(19) United States
(12) Patent Application Publication
(10) Pub. No.: US 2008/0158547 A1
(43) Pub. Date: Jul. 3, 2008

(54) Motion detecting device for sensing rotation and inclination variation information and method of using the same

(75) Inventors: Chia-Chu Cheng, Hsin-Tien City (TW); Yu-Wei Lu, Hsin-Tien City (TW); Ya-Lun Lee, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORPORATION

(21) Appl. No.: 11/647,290

(22) Filed: Dec. 29, 2006

(51) Int. Cl. G01N 21/00

(52) U.S. Cl. 356/72

(57) ABSTRACT

A motion detecting device for sensing rotation and inclination variation information, includes a light-emitting unit, a sensor control unit, an image sensing unit, a rotation-sensing unit, an inclination-sensing unit, a data storing unit, and an operation unit. The image sensing unit is used to receive a light-reflecting signal. The rotation-sensing unit is used to sense a rotation variation signal of the motion detecting device. The inclination-sensing unit is used to sense an inclination variation signal of the motion detecting device. The operation unit is used to calculate a motion direction and a motion velocity of the motion detecting device relative to a motion surface according to the light-reflecting signal from the image-sensing unit, a rotation angle of the motion detecting device according to the rotation variation signal, and an inclination angle of the motion detecting device according to the inclination variation signal.

### BACKGROUND OF THE INVENTION

1. Field of the Invention

The present invention relates to a motion detecting device and a method of using the same, and particularly relates to a motion detecting device for sensing rotation and inclination variation information, and a method of sensing rotation and inclination variation information for a motion detecting device

2. Description of the Related Art

A known handwriting input device is composed of a magnetic handwriting digital panel and a touch pen. Alternatively, it is composed of a digital panel with an LCD and a touch pen.

Referring to FIG. 1, when the known magnetic handwriting digital panel B and touch pen P are in use, the touch pen P does not write down anything on the digital panel B. The tacks or handwritings are displayed on a monitor D that connects to a computer host C. For example, when a user uses the touch pen P to write the letter “W” on the digital panel B, the letter “W” is shown on the monitor D via the computer host C. However, when the user uses the touch pen P to write the number of strokes required for a character or a picture, the strokes are not continuous. Hence, the strokes can not be shown correctly on the monitor D. It is inconvenient for user.

Although a digital panel with an LCD can show all of the strokes on the LCD, the digital panel with the LCD is expensive. The cost is not affordable for most users.

According to the above-mentioned method, no matter which method is used, the touch pen always needs to work in tandem with the digital panel. Hence, not only is the cost high, but it is also inconvenient for the user to carry both the panel and the touch pen around together.

Moreover, with regard to the “optical motion detecting device”, when it is moved relative to a detection surface and is rotated or inclined, the motion track information that is captured via the optical motion detecting device is distorted. Hence, the known optical motion detecting device will make an incorrect judgment regarding the motion track information.

### SUMMARY OF THE INVENTION

The present invention provides a motion detecting device for sensing rotation and inclination variation information. The motion detecting device has a rotation-sensing unit and an inclination-sensing unit for respectively detecting “rotation variation signals” and “inclination variation signals” when the motion detecting device is being used. Hence, a motion direction and a motion velocity of the motion detecting device relative to a motion surface can be adjusted via the rotation variation signals and the inclination variation signals, in order to output a correct motion track from the motion detecting device.

The first aspect of the invention is a motion detecting device for sensing rotation and inclination variation information, including: a light-emitting unit, a sensor control unit, an image-sensing unit, a rotation-sensing unit, an inclination-sensing unit, a data-storing unit, and an operation unit.

Moreover, the light-emitting unit is used to project a light source to a detection surface to generate a light-reflecting signal. The sensor control unit is used to provide a system timing clock. The image-sensing unit is electrically connected to the sensor control unit for sensing the light-reflecting signal, the rotation-sensing unit is electrically connected to the sensor control unit for sensing a rotation variation signal of the motion detecting device, and the inclination-sensing unit is electrically connected to the sensor control unit for sensing an inclination variation signal of the motion detecting device.

In addition, the data-storing unit is electrically connected to the sensor control unit for storing the light-reflecting signal from the image-sensing unit, the rotation variation signal from the rotation-sensing unit, and the inclination variation signal from the inclination-sensing unit.

The operation unit is electrically connected to the sensor control unit and the data-storing unit. Therefore, a motion direction and a motion velocity of the motion detecting device relative to the motion surface are determined via the operation unit according to the light-reflecting signal from the image-sensing unit. A rotation angle of the motion detecting device is determined via the operation unit according to the rotation variation signal. An inclination angle of the motion detecting device is determined via the operation unit according to the inclination variation signal.

The second aspect of the invention is a method of sensing rotation and inclination variation information for a motion detecting device, including: projecting a light source to a detection surface to generate a light-reflecting signal via a light-emitting unit; controlling an image-sensing unit that is electrically connected to a sensor control unit for sensing the light-reflecting signal via a system timing clock that is provided from the sensor control unit; controlling a rotation-sensing unit that is electrically connected to the sensor control unit for sensing a rotation variation signal of the motion detecting device via the system timing clock; and controlling an inclination-sensing unit that is electrically connected to the sensor control unit for sensing an inclination variation signal of the motion detecting device via the system timing clock.

The method further includes: storing the light-reflecting signal from the image-sensing unit, the rotation variation signal from the rotation-sensing unit and the inclination variation signal from the inclination-sensing unit in a data-storing unit that is electrically connected to the sensor control unit; and determining a motion direction and a motion velocity of the motion detecting device relative to the motion surface by an operation unit that is electrically connected to the sensor control unit and the data-storing unit, according to the light-reflecting signal from the image-sensing unit.

Furthermore, the method further includes: determining a rotation angle of the motion detecting device via the operation unit according to the rotation variation signal; determining an inclination angle of the motion detecting device via the operation unit according to the inclination variation signal; and adjusting the motion direction and the motion velocity of the motion detecting device relative to the motion surface via the rotation angle and the inclination angle, in order to output a correct motion track from the motion detecting device.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a schematic view of a digital panel matched with a touch pen according to a prior art;

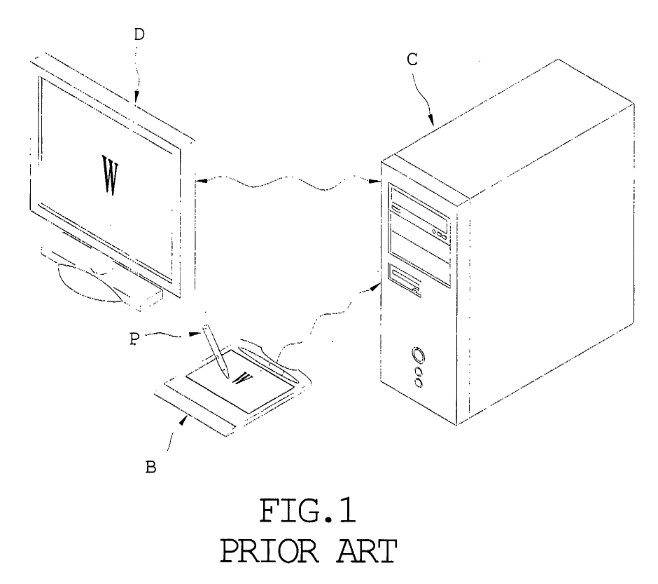

FIG. 2 is a function block of a motion detecting device for sensing rotation and inclination variation information according to the first embodiment of the present invention;

FIG. 3 is a function block of a motion detecting device for sensing rotation and inclination variation information according to the second embodiment of the present invention;

FIG. 4 is a cross-sectional, schematic view of a light-emitting unit mated with an image-sensing unit according to the first embodiment of the present invention;

FIG. 5 is a cross-sectional, schematic view of a light-emitting unit mated with an image-sensing unit according to the second embodiment of the present invention;

FIG. 6 is a cross-sectional, schematic view of a light-emitting unit mated with an image-sensing unit according to the third embodiment of the present invention; and

FIG. 7 is a flowchart of a method of sensing rotation and inclination variation information for a motion detecting device according to the present invention.

### DETAILED DESCRIPTION OF PREFERRED EMBODIMENTS

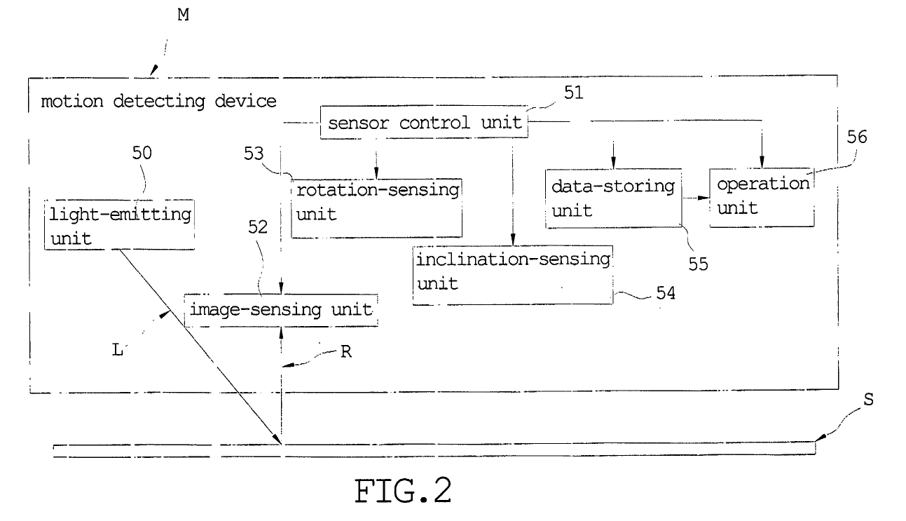

Referring to FIG. 2, the present invention of the first embodiment provides a motion detecting device M for sensing rotation and inclination variation information, including: a light-emitting unit 50, a sensor control unit 51, an image-sensing unit 52, a rotation-sensing unit 53, an inclination-sensing unit 54, a data-storing unit 55, and an operation unit 56.

The light-emitting unit 50 is used to project a light source L onto a detection surface S to generate a light-reflecting signal R. The sensor control unit 51 is used to provide a system timing clock. In addition, the image-sensing unit 52 is electrically connected to the sensor control unit 51 for sensing the light-reflecting signal R.

Moreover, the rotation-sensing unit 53 is electrically connected to the sensor control unit 51 for sensing a rotation variation signal of the motion detecting device M. The rotation-sensing unit 53 can be a magnetic sensor. In other words, when the motion detecting device M detects the motion of the detection surface S, the motion detecting device M is rotated at the same time. Because the motion detecting device M is rotated, an included angle between the motion detecting device M and a global magnetic field is changed according to rotation degrees of the motion detecting device M. Hence, the rotation-sensing unit 53 can be used to sense different included angle variations (magnetic field intensity variations) of the motion detecting device M relative to the global magnetic field, in order to figure out rotation angle variation information of the motion detecting device M.

In addition, the rotation-sensing unit 53 is electrically connected to the sensor control unit 51 for sensing a rotation variation signal of the motion detecting device M. The rotation-sensing unit 53 can be an angular velocity sensor such as a gyroscope. In other words, when the motion detecting device M detects the motion of the detection surface S, the motion detecting device M is rotated at the same time. When the motion detecting device M is rotated, the motion detecting device M generates an angular momentum variation. Hence, the rotation-sensing unit 53 can be used to sense different angular momentum variations of the motion detecting device M, in order to figure out rotation angle variation information of the motion detecting device M.

Furthermore, the inclination-sensing unit 54 is electrically connected to the sensor control unit 51 for sensing an inclination variation signal of the motion detecting device M. The inclination-sensing unit 54 can be an acceleration sensor. In other words, when the motion detecting device M detects the motion of the detection surface S, the motion detecting device M is inclined at the same time. Because the motion detecting device M is inclined, an included angle between the motion detecting device M and a global surface is changed according to inclination degrees of the motion detecting device M. Hence, the inclination-sensing unit 54 can be used to sense different included angle variations (gravity variations) of the motion detecting device M relative to the global surface, in order to figure out inclination angle variation information of the motion detecting device M.

Moreover, the data-storing unit 55 is electrically connected to the sensor control unit 51 (the data-storing unit 55 can also be electrically connected with the image-sensing unit 52, the rotation-sensing unit 53 and the inclination-sensing unit 54) for storing the light-reflecting signal R from the image-sensing unit 52, the rotation variation signal from the rotation-sensing unit 53, and the inclination variation signal from the inclination-sensing unit 54.

Furthermore, the operation unit 56 is electrically connected to the sensor control unit 51 and the data-storing unit 55. Therefore, a motion direction and a motion velocity of the motion detecting device M relative to the motion surface S are determined via the operation unit 56 according to the light-reflecting signal R from the image-sensing unit 52. A rotation angle of the motion detecting device M is determined via the operation unit 56 according to the rotation variation signal, and an inclination angle of the motion detecting device M is determined via the operation unit 56 according to the inclination variation signal.

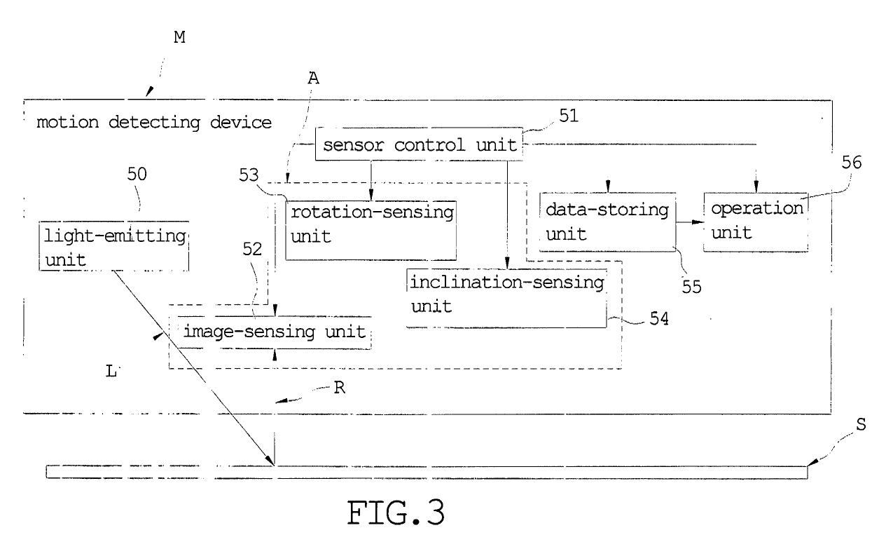

Referring to FIG. 3, the present invention of the second embodiment provides a motion detecting device M for sensing rotation and inclination variation information. The difference between the second embodiment and the first embodiment is that in the second embodiment the image-sensing unit 52, the rotation-sensing unit 53 and the inclination-sensing unit 54 are installed in the same chip A.

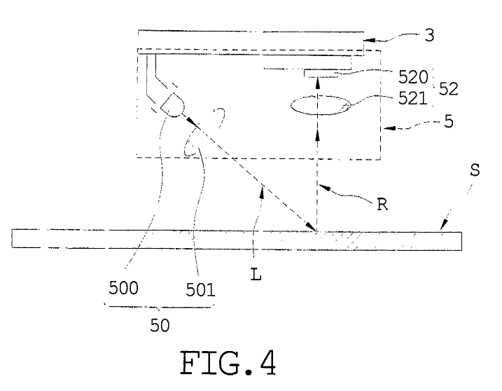

Referring to FIG. 4, a cross-sectional, schematic view of a light-emitting unit mated with an image-sensing unit according to the first embodiment of the present invention is shown. In the first embodiment the light-emitting unit 50 is composed of a light-emitting element 500 and a collimation lens 501. The light-emitting element 500 is electrically connected to a PCB 3, and a mirrored surface of the collimation lens 501 can be a spherical surface or an aspheric surface. Moreover, the light-emitting unit 50 can be a coherent light-emitting element or a noncoherent light-emitting element. In other words, the light-emitting element 500 can be a coherent light-emitting element or a noncoherent light-emitting element.

If the light-emitting element 500 is a coherent light-emitting element the light-emitting unit 50 is composed of a coherent light-emitting element and a collimation lens 501. The coherent light-emitting element is composed of one or many lasers or VCSELs (Vertical Cavity Surface-Emitting Lasers). If the light-emitting element 500 is a noncoherent light-emitting element the light-emitting unit 50 is composed of a noncoherent light-emitting element and a collimation lens 501, and the noncoherent light-emitting element is composed of one or many LEDs.

Furthermore, the image-sensing unit 52 can be composed of a linear sensor array 520 (or many linear sensor arrays) and an imaging lens 521. The linear sensor array 520 is electrically connected with the PCB 3.

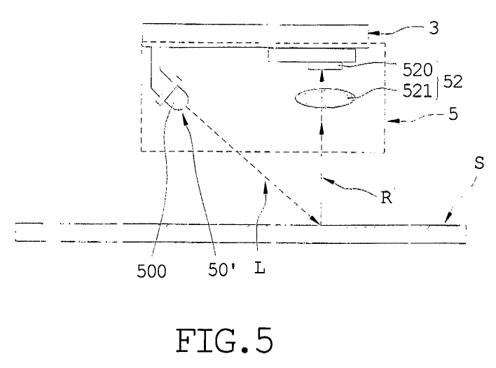

Referring to FIG. 5, a cross-sectional, schematic view of a light-emitting unit mated with an image-sensing unit according to the second embodiment of the present invention is shown. The difference between the second embodiment and the first embodiment is that in the second embodiment the light-emitting unit 50′ is the light-emitting element 500 (omitting the collimation lens 501 of the first embodiment). A light source of the light-emitting unit 50′ can be a coherent light source or a noncoherent light source. In other words, the light-emitting element 500 can be a coherent light-emitting element or a noncoherent light-emitting element.

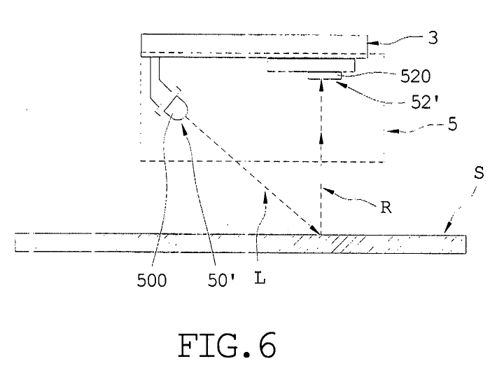

Referring to FIG. 6, a cross-sectional, schematic view of a light-emitting unit mated with an image-sensing unit according to the third embodiment of the present invention is shown. The difference between the third embodiment and the second embodiment is that in the third embodiment the imaging lens 521 (as shown in FIG. 5.) is omitted. Hence, the image-sensing unit 52′ is a linear sensor array 520 (or a number of linear sensor arrays).

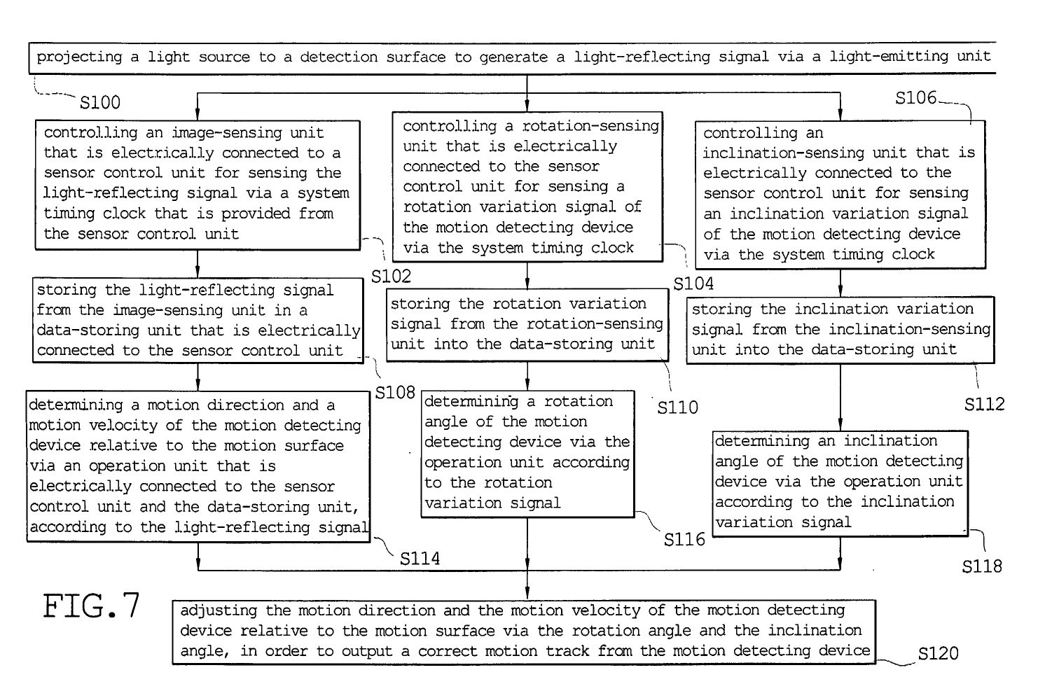

Referring to FIG. 7, a flowchart of a method of sensing rotation and inclination variation information for a motion detecting device according to the present invention is shown. The method including: projecting a light source L to a detection surface S to generate a light-reflecting signal R via a light-emitting unit 50 (S100); and controlling an image-sensing unit 52 that is electrically connected to a sensor control unit 51 for sensing the light-reflecting signal R via a system timing clock that is provided from the sensor control unit 51 (S102).

In addition, the method further includes: controlling a rotation-sensing unit 53 that is electrically connected to the sensor control unit 51 for sensing a rotation variation signal of the motion detecting device M via the system timing clock (S104); and controlling an inclination-sensing unit 54 that is electrically connected to the sensor control unit 51 for sensing an inclination variation signal of the motion detecting device M via the system timing clock (S106).

Moreover, the method further includes: storing the light-reflecting signal from the image-sensing unit 52 in a data-storing unit 55 that is electrically connected to the sensor control unit 51 (S108); storing the rotation variation signal from the rotation-sensing unit 53 into the data-storing unit 55 (S110); and storing the inclination variation signal from the inclination-sensing unit 54 into the data-storing unit 55 (S112). In addition, the image-sensing unit 52 is electrically connected with or is insulated from the data-storing unit 55. The rotation-sensing unit 53 is electrically connected with or is insulated from the data-storing unit 55. The inclination-sensing unit 54 is electrically connected with or is insulated from the data-storing unit 55.

Hence, the light-reflecting signal R from the image-sensing unit 52, the rotation variation signal from the rotation-sensing unit 53 and the inclination variation signal from the inclination-sensing unit 54 are stored directly into the data-storing unit 55 or are stored indirectly into the data-storing unit 55 via the sensor control unit 51.

Furthermore, the method further includes: determining a motion direction and a motion velocity of the motion detecting device M relative to the motion surface S via an operation unit 56 that is electrically connected to the sensor control unit 51 and the data-storing unit 55, according to the light-reflecting signal R from the image-sensing unit 52 (S114).

Moreover, the method further includes: determining a rotation angle of the motion detecting device M via the operation unit 56 according to the rotation variation signal (S116); determining an inclination angle of the motion detecting device M via the operation unit 56 according to the inclination variation signal (S118); and adjusting the motion direction and the motion velocity of the motion detecting device M relative to the motion surface S via the rotation angle and the inclination angle, in order to output a correct motion track from the motion detecting device M (S120).

In conclusion, the rotation-sensing unit 53 and the inclination-sensing unit 54 are used to respectively detect “rotation variation signals” and “inclination variation signals” while the motion detecting device M is being used. Hence, the motion direction and the motion velocity of the motion detecting device M relative to the motion surface S can be adjusted via “the rotation variation signals” and “the inclination variation signals”, in order to output a correct motion track from the motion detecting device M.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A motion detecting device for sensing rotation and inclination variation information, comprising:
a light-emitting unit for projecting a light source to a detection surface to generate a light-reflecting signal;
a sensor control unit for providing a system timing clock;
an image-sensing unit electrically connected to the sensor control unit for sensing the light-reflecting signal;
a rotation-sensing unit electrically connected to the sensor control unit for sensing a rotation variation signal of the motion detecting device;
an inclination-sensing unit electrically connected to the sensor control unit for sensing an inclination variation signal of the motion detecting device;
a data-storing unit electrically connected to the sensor control unit for storing the light-reflecting signal from the image-sensing unit, the rotation variation signal from the rotation-sensing unit, and the inclination variation signal from the inclination-sensing unit;
an operation unit electrically connected to the sensor control unit and the data-storing unit, wherein a motion direction and a motion velocity of the motion detecting device relative to the motion surface are determined via the operation unit according to the light-reflecting signal from the image-sensing unit, a rotation angle of the motion detecting device is determined via the operation unit according to the rotation variation signal, and an inclination angle of the motion detecting device is determined via the operation unit according to the inclination variation signal.

2. The motion detecting device as claimed in claim 1, wherein the light-emitting unit is a coherent light-emitting element, and the coherent light-emitting element is composed of one or a number of lasers or VCSELs (Vertical Cavity Surface-Emitting Lasers).

3. The motion detecting device as claimed in claim 1, wherein the light-emitting unit is composed of a coherent light-emitting element and a collimation lens, and a mirrored surface of the collimation lens is a spherical surface or an aspheric surface.

4. The motion detecting device as claimed in claim 1, wherein the light-emitting unit is a noncoherent light-emitting element, and the noncoherent light-emitting element is composed of one or many LEDs.

5. The motion detecting device as claimed in claim 1, wherein the light-emitting unit is composed of a noncoherent light-emitting element and a collimation lens, and a mirrored surface of the collimation lens is a spherical surface or an aspheric surface.

6. The motion detecting device as claimed in claim 1, wherein the image-sensing unit is composed of one or many linear sensor arrays.

7. The motion detecting device as claimed in claim 1, wherein the image-sensing unit is composed of a linear sensor array and an imaging lens.

8. The motion detecting device as claimed in claim 1, wherein the rotation-sensing unit is a magnetic sensor or an angular velocity sensor, the inclination-sensing unit is an acceleration sensor, and the angular velocity sensor is a gyroscope.

9. The motion detecting device as claimed in claim 1, wherein the image-sensing unit, the rotation-sensing unit and the inclination-sensing unit are installed in the same chip, and the data-storing unit is electrically connected to the rotation-sensing unit and the inclination-sensing unit.

10. A method of sensing rotation and inclination variation information for a motion detecting device, comprising:
projecting a light source to a detection surface to generate a light-reflecting signal via a light-emitting unit;
controlling an image-sensing unit that is electrically connected to a sensor control unit for sensing the light-reflecting signal via a system timing clock that is provided from the sensor control unit;
controlling a rotation-sensing unit that is electrically connected to the sensor control unit for sensing a rotation variation signal of the motion detecting device via the system timing clock;
controlling an inclination-sensing unit that is electrically connected to the sensor control unit for sensing an inclination variation signal of the motion detecting device via the system timing clock;
storing the light-reflecting signal from the image-sensing unit, the rotation variation signal from the rotation-sensing unit and the inclination variation signal from the inclination-sensing unit in a data-storing unit that is electrically connected to the sensor control unit;
determining a motion direction and a motion velocity of the motion detecting device relative to the motion surface by an operation unit that is electrically connected to the sensor control unit and the data-storing unit, according to the light-reflecting signal from the image-sensing unit,
determining a rotation angle of the motion detecting device via the operation unit according to the rotation variation signal;
determining an inclination angle of the motion detecting device via the operation unit according to the inclination variation signal; and
adjusting the motion direction and the motion velocity of the motion detecting device relative to the motion surface via the rotation angle and the inclination angle, in order to output a correct motion track from the motion detecting device.

11. The method as claimed in claim 10, wherein the light-emitting unit is a coherent light-emitting element, and the coherent light-emitting element is composed of one or a number of lasers or VCSELs (Vertical Cavity Surface-Emitting Lasers).

12. The method as claimed in claim 10, wherein the light-emitting unit is composed of a coherent light-emitting element and a collimation lens, and a mirrored surface of the collimation lens is a spherical surface or an aspheric surface.

13. The method as claimed in claim 10, wherein the light-emitting unit is a noncoherent light-emitting element, and the noncoherent light-emitting element is composed of one or many LEDs.

14. The method as claimed in claim 10, wherein the light-emitting unit is composed of a noncoherent light-emitting element and a collimation lens, and a mirrored surface of the collimation lens is a spherical surface or an aspheric surface.

15. The method as claimed in claim 10, wherein the image-sensing unit is composed of one or many linear sensor arrays.

16. The method as claimed in claim 10, wherein the image-sensing unit is composed of a linear sensor array and an imaging lens.

17. The method as claimed in claim 10, wherein the rotation-sensing unit is a magnetic sensor or an angular velocity sensor, the inclination-sensing unit is an acceleration sensor, and the angular velocity sensor is a gyroscope.

18. The method as claimed in claim 10, wherein the image-sensing unit, the rotation-sensing unit, and the inclination-sensing unit are installed in the same chip.

19. The method as claimed in claim 10, wherein the light-reflecting signal from the image-sensing unit, the rotation variation signal from the rotation-sensing unit and the inclination variation signal from the inclination-sensing unit are stored directly into the data-storing unit.

20. The method as claimed in claim 10, wherein the light-reflecting signal from the image-sensing unit, the rotation variation signal from the rotation-sensing unit and the inclination variation signal from the inclination-sensing unit are stored indirectly into the data-storing unit via the sensor control unit.
